(19) United States
(12) Patent Application Publication
(10) Pub. No.: US 2008/0066326 A1
(43) Pub. Date: Mar. 20, 2008

(54) Apparatus and Method for cutting electrical outlet holes on gypsum board

(76) Inventors: Jeff A. Reed, Round Rock, TX (US); Charles David Collier, Pflugerville, TX (US)

Correspondence Address: RICK B. YEAGER, ATTORNEY, 10805 MELLOW LANE, AUSTIN, TX, 78759, US

(21) Appl. No.: 11/856,561

(22) Filed: Sep. 17, 2007

Related U.S. Application Data
(60) Provisional application No. 60/845,024, filed on Sep. 15, 2006.

(51) Int. Cl. B23D 51/16; B27B 19/00

(52) U.S. Cl. 30/392; 30/501

(57) ABSTRACT

A saw for cutting a rectangular hole for electrical or data outlets in gypsum board. The saw includes a handle, and rectangular frame cutting element that cuts all four sides of a rectangular hole in a single operation. Each cutting surface on the frame typically has several sets of stepped teeth so that the highest tooth in the step engages the board first; then the second highest tooth engages the board after the first tooth has partially cut into the board. This stepped tooth approach provides an effect similar to have started several separate saws independently along each of the four sides of the hole. The handle provides leverage to effectively engage each of these sets of teeth at the same time. The tool is typically worked by moving the handle side to side or up and down in short strokes to move the teeth through the board.

### RELATED APPLICATIONS

This non-provisional patent application is related to Provisional Patent Application No. 60/845,024 filed by applicants on Sep. 15, 2006, and claims the filing date of that application.

### FIELD OF INVENTION

This invention relates to cutting a rectangular hole for electrical or data outlets in gypsum board. The device and method is faster, easier, lower cost, and more accurate than prior art techniques.

### BACKGROUND

Currently holes for electrical outlets or data outlets are cut into gypsum board, or sheetrock, after first measuring where the outlet is to be placed in comparison with the size of gypsum board and then making the cut with a hand held sheetrock saw. This tends to lead to misplacement and over-sizing of the outlet cut. The misplacement and resulting over-sizing of the final hole then typically requires caulking of the outlet before the covers can be placed over the outlets. If the caulk is not applied, then there may be a hole in the gypsum board that is not hidden the cover.

This prior art technique for providing holes in gypsum board is slow because it requires 4 separate cuts to make a rectangular hole. As described above, this prior art technique is often inaccurate. The prior art technique is expensive because of the time required to make the hole, and because of the frequent caulking or patching required. There is a need for a faster, cheaper, and more accurate method of providing the outlet holes.

### SUMMARY OF INVENTION

The current invention is a saw that will cut a rectangular hole to facilitate an electrical or data outlet opening with one quick and easy cutting operation. In one embodiment, the saw includes a handle, a rectangular frame cutting element that cuts all four sides of a rectangular hole in a single operation. Each cutting surface on the frame typically has several sets of stepped teeth so that the highest tooth in the step engages the board first; then the second highest tooth engages the board after the first tooth has partially cut into the board. This stepped tooth approach provides an effect similar to have started several separate saws independently along each of the four sides of the hole. The handle provides leverage to effectively engage each of these sets of teeth at the same time, so that all four sides are cut quickly in a single operation. The tool is typically worked by moving the handle side to side or up and down in short strokes to move the teeth through the board. The teeth on all four edges are held in proper alignment by the frame.

### BRIEF DESCRIPTION OF THE DRAWINGS

These and other objects and advantages of the present invention are set forth below and further made clear by reference to the drawings, wherein:

FIG. 1 is one side view of one embodiment of the saw, showing a handle, a rectangular frame, and several sets of cutting teeth.

FIG. 2 is second side view of the saw embodiment of FIG. 1 rotated 90 degrees, also showing a handle, a rectangular frame, and several sets of cutting teeth.

FIG. 3 is a perspective view of the saw of FIG. 1.

FIG. 4 is a bottom view of the saw of FIG. 1.

### DETAILED DESCRIPTION OF EMBODIMENT

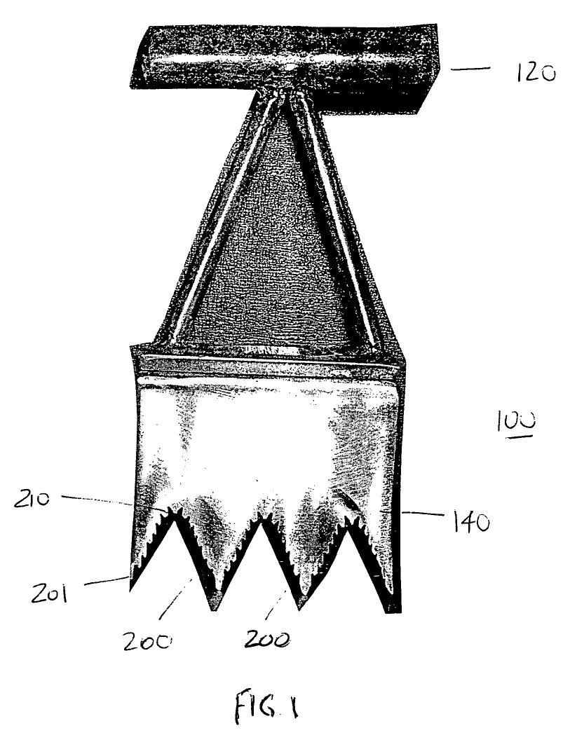

FIG. 1 is one side view of one embodiment of the saw 100, showing a handle 120, a rectangular frame 140, and several sets of cutting teeth 200. Each set of cutting teeth is stepped from a first and highest tooth 201 to a last and lowest tooth 210. Various profiles of cutting teeth can be used. In this example, there are 6-8 teeth per set. Each corner of the frame preferably has a high tooth.

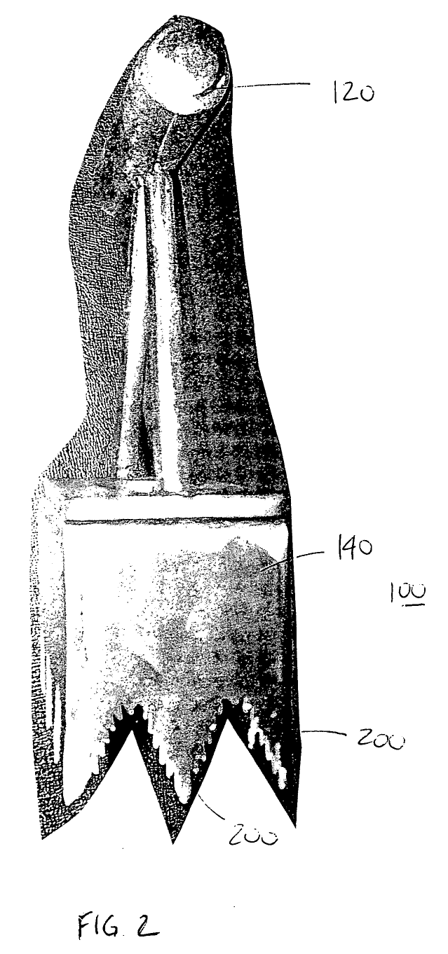

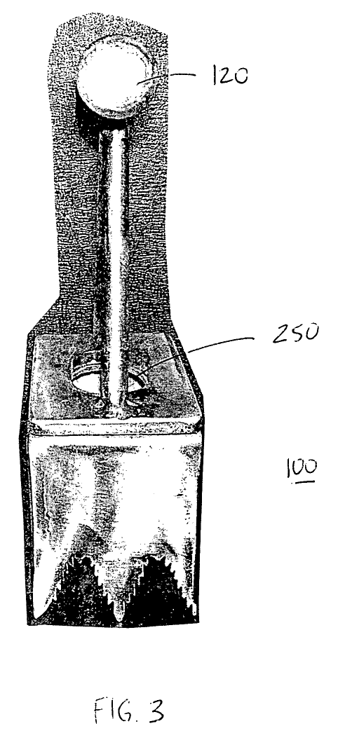

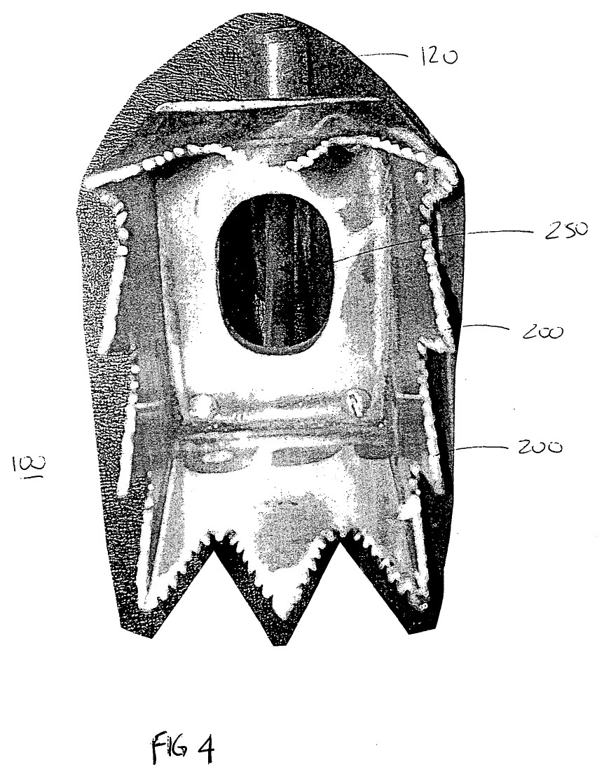

FIG. 2 is second side view of the saw embodiment of FIG. 1 rotated 90 degrees, also showing a handle, a rectangular frame, and several sets of cutting teeth. FIG. 3 is a perspective view of the saw of FIG. 1 showing a spoils removal hole 250. FIG. 4 is a bottom view of the saw of FIG. 1.

This box type saw has teeth on four sides using six points with teeth on either side of the points and a handle mounted to the back of the box.

To cut a hole for an outlet the blade should be held straight or on the marked gyp-board (sheetrock). While pressing the blade against a sheetrock wall, an up and down motion will “saw” an outlet box sized hole in about 5 to 10 seconds. The blade is designed to fit either a standard switch box, a “snap-in box” or a box eliminator.

### Description of Embodiment—Box Saw With Level

In this embodiment there is a small level on top for leveling the opening before cutting.

### Description of Embodiment—Box Saw With Height Indicator

In this embodiment there is a metal ruler for accurate height adjustment which can be adjusted with a thumb screw.

### Description of Embodiment—Spring Loaded Box Saw

In this embodiment there is a spring loaded blade cover that retracts as you make your hole.

### Description of Embodiment—Power Driven Box Saw

In this embodiment there is a possible attachment to an electrical or battery operated power tool device and each configuration of handle can be modified to work with power, but with the manual operation only lasting seconds for each cut. The use of power is not necessary with this box saw invention.

### Description of Embodiment—Alternate Handles

In this embodiment the handles are of several types. One is for hand operation, one for using a hammer. The blade is attached to the handle using four screws.

The time that this saw saves greatly improves on any existing job. This saw eliminates the need to carry a cordless power tool, reducing the weight carried by the technician during projects.

The embodiments described above represent a few designs for a saw. Various combinations of size of the frame, depth of the box frame, number of teeth per point or set, size of teeth, pitch of teeth, sharpness of teeth, sharpness of points, length of points, shape of teeth, size of spoil removal hole, shape of handle, type of handle, type of material for saw, type of material for handle, thickness of metal for the saw, connection of the saw to the handle, type of fastener for connection of saw to the handle can be used without departing from the current invention.

The examples described above are for illustration, and it will be apparent to those skilled in the art that various alterations to the device design and operation may be made.

What is claimed is

1. A saw comprising
a handle; and
a rectangular frame cutting element comprising
a first edge comprising
a plurality of sets of teeth, each set of teeth comprising
a first tooth,
a second tooth, shorter than the first tooth, and
a third tooth, shorter than the second tooth,
a second edge generally perpendicular to the first edge, the second edge comprising a plurality of sets of teeth,
a third edge generally parallel to the first edge, the third edge comprising a plurality of sets of teeth, and
a fourth edge generally parallel to the second edge, the fourth edge comprising a plurality of sets of teeth.

2. The saw of claim 1 wherein the rectangular frame cutting element further comprises a rear wall.

3. The saw of claim 2 wherein the rear wall has at least one hole.

4. The saw of claim 1 wherein the first edge further comprises
a first corner;
a first corner set of teeth having
an outside first corner long tooth in proximity to the first corner,
a first corner second tooth adjacent to and shorter than the first corner long tooth, and
a first corner third tooth adjacent to and shorter than the first corner second tooth;
a second corner;
a second corner set of teeth having
an outside second corner long tooth in proximity to the second corner,
a second corner second tooth adjacent to and shorter than the second corner long tooth, and
a second corner third tooth adjacent to and shorter than the second corner second tooth; and
at least one intermediate set of teeth comprising
a first intermediate center long tooth having a length approximately the same as the outside first corner tooth,
a pair of intermediate second teeth positioned on either side of the first intermediate center long tooth, each intermediate second tooth having a length approximately the same as the first corner second tooth, and
a pair of intermediate third teeth, each third tooth positioned adjacent to an intermediate second teeth, each third tooth having a length approximately the same as the first corner third tooth.

5. The saw of claim 1 wherein each set of teeth has teeth of 6 to 8 different lengths.

6. The saw of claim 1 wherein the rectangular frame cutting element further comprises level.

7. The saw of claim 1 wherein the rectangular frame cutting element further comprises a height indicator.

8. The saw of claim 7 wherein the height indicator further comprises a ruler with a thumb screw adjustment.

9. The saw of claim 1 wherein the rectangular frame cutting element further comprises
a spring loaded blade cover.

10. A tool comprising
a reciprocating power tool, and
a rectangular frame cutting element attached to the power tool, the rectangular frame cutting element comprising
a first edge comprising
a plurality of sets of teeth, each set of teeth comprising
a first tooth,
a second tooth, shorter than the first tooth, and
a third tooth, shorter than the second tooth,
a second edge generally perpendicular to the first edge, the second edge comprising a plurality of sets of teeth,
a third edge generally parallel to the first edge, the third edge comprising a plurality of sets of teeth, and
a fourth edge generally parallel to the second edge, the fourth edge comprising a plurality of sets of teeth.

11. A method for cutting a rectangular hole in wallboard, the method comprising
providing a saw comprising
a handle, and
a rectangular frame cutting element comprising
a first edge comprising
a plurality of sets of teeth, each set of teeth comprising
a first tooth,
a second tooth, shorter than the first tooth, and
a third tooth, shorter than the second tooth,
a second edge generally perpendicular to the first edge, the second edge comprising a plurality of sets of teeth,
a third edge generally parallel to the first edge, the third edge comprising a plurality of sets of teeth, and
a fourth edge generally parallel to the second edge, the fourth edge comprising a plurality of sets of teeth;
starting the hole by
positioning the saw at a desired location,
applying a force on the saw in the direction of the wallboard, and
moving the handle back and forth or up and down;
continuing to drill the hole by moving the saw back and forth or up and down; and
removing the saw from the hole when the hole is completed.

12. The method of claim 11 wherein
providing a saw further comprises providing a level on the saw; and
positioning the saw at a desired location further comprises using the level to orient the saw.

13. The method of claim 11 wherein
providing a saw further comprises providing a height indicator; and
positioning the saw at a desired location further comprises using the height indicator to position the saw at a desired height.

14. The method of claim 11 wherein
applying a force further comprises hitting the handle with a hammer.

15. The method of claim 11 wherein
applying a force further comprises attaching the saw to a power tool.
